(19) United States
(12) Patent Application Publication
(10) Pub. No.: US 2012/0249507 A1
(43) Pub. Date: Oct. 4, 2012

(54) DRIVING APPARATUS AND DRIVING METHOD OF DISPLAY DEVICE

(76) Inventors: JAE-SEOB CHUNG, Asan-si (KR); Seung Rock Choi, Seongnam-si (KR); Yong-Ju Jeong, Asan-si (KR); Sung-Yeol Baek, Seoul (KR)

(21) Appl. No.: 13/243,933

(22) Filed: Sep. 23, 2011

(30) Foreign Application Priority Data
Mar. 28, 2011 (KR) 10-2011-0027697

(51) Int. Cl. G09G 5/00; G09G 3/36

(52) U.S. Cl. 345/211; 345/204; 345/87

(57) ABSTRACT

A driving apparatus and a driving method of a liquid crystal display according to an exemplary embodiment of the present invention may remove or reduce flicker caused by a kickback voltage according to an inversion driving mode of the liquid crystal display even though the inversion driving mode is changed.

### CROSS-REFERENCE TO RELATED APPLICATION

This application claims priority to and the benefit of Korean Patent Application No. 10-2011-0027697 filed in the Korean Intellectual Property Office on Mar. 28, 2011, the entire contents of which are herein incorporated by reference.

### BACKGROUND

(a) Technical Field

The embodiments of the present invention are directed to a driving apparatus and a driving method of a display device.

(b) Discussion of the Related Art

A liquid crystal display (hereinafter referred to as an “LCD”) is a type of flat panel display device. The LCD includes two display panels provided with electric field generating electrodes, such as pixel electrodes and a common electrode, and a liquid crystal layer interposed between the two display panels. Voltages are applied to the electric field generating electrodes to generate an electric field in the liquid crystal layer. Due to the generated electric field, liquid crystal molecules of the liquid crystal layer are aligned and polarization of incident light is controlled, thereby displaying images.

To prevent degradation of display quality of the liquid crystal display, an inversion driving method may be used. However, the inversion driving method may cause flicker due to a kickback voltage. The flicker changes as the inversion mode changes, which makes it difficult to remove the flicker.

### SUMMARY

The embodiments of the present invention provide a driving apparatus and method for driving a liquid crystal display that remove or reduce flicker caused by a kickback voltage even though an inversion mode of the liquid crystal display is changed.

According to an embodiment of the present invention, a driving apparatus of a liquid crystal display includes a signal modification unit that determines an inversion driving mode of the liquid crystal display, modifies a signal according to the determined inversion driving mode, and outputs a modification signal to remove or reduce flicker according to the inversion driving mode.

The inversion driving mode includes a first inversion driving mode and a second inversion driving mode. A first modification common voltage to remove or reduce flicker in the first inversion driving mode and a second modification common voltage to remove or reduce flicker in the second inversion driving mode may be different. The signal modification unit may include a memory unit storing the first modification common voltage and the second modification common voltage.

The signal modification unit includes a digital variable resistor (DVR) generating the first and second modification common voltages.

The modification signal of the signal modification unit changes an offset of the digital variable resistor (DVR) according to a difference between the first modification common voltage and the second modification common voltage from the memory unit.

The modification signal of the signal modification unit changes duration of a gate-on signal.

The modification signal of the signal modification unit changes the duration of the gate-on signal by controlling timing of a gate clock signal (CPV).

The modification signal of the signal modification unit may change a magnitude of a gate-on signal and a magnitude of a gate-off signal.

The signal modification unit inputs an input signal to a register controlling the size of the gate-on signal and the gate-off signal through a DC/ DC converter.

The inversion driving mode includes a first inversion driving mode and a second inversion driving mode. The signal modification unit includes a memory unit storing a first lookup table for the first inversion driving mode and a second lookup table for the second inversion driving mode.

The signal modification unit reads one of the first lookup table and the second lookup table from the memory according to an input signal and outputs the modification image signal according to the read lookup table.

According to an embodiment of the present invention, a driving method of a liquid crystal display includes determining an inversion driving mode of the liquid crystal display from an input control signal and outputting a modification signal to remove or reduce flicker according to the determined inversion driving mode.

The inversion driving mode includes a first inversion driving mode and a second inversion driving mode. A first modification common voltage to remove or reduce flicker in the first inversion driving mode and a second modification common voltage to remove or reduce flicker in the second inversion driving mode are different from each other. The driving method further includes reading a first modification common voltage and a second modification common voltage from a memory unit storing the first modification common voltage and the second modification common voltage.

The driving method further includes changing an offset of a digital variable resistor (DVR), which generates the first and second modification common voltages according to a difference of the first modification common voltage and the second modification common voltage.

The driving method further includes changing the duration of a gate-on signal.

The driving method further includes changing the duration of the gate-on signal by controlling timing of a gate clock signal (CPV).

The driving method further includes changing a magnitude of a gate-on signal and a magnitude of a gate-off signal.

The driving method further includes inputting an input signal to a register controlling the magnitude of the gate-on signal and the magnitude of the gate-off signal through a DC/DC converter.

The inversion driving mode includes a first inversion driving mode and a second inversion driving mode. The driving method includes reading one of a first lookup table for the first inversion driving mode and a second lookup table for the second inversion driving mode from a memory unit storing the first lookup table and the second lookup table and outputting a modification image signal according to the read lookup table.

The liquid crystal display and the driving method of the liquid crystal display according to the exemplary embodiments of the present invention may remove or reduce flicker according to an inversion driving mode even though the inversion mode of the liquid crystal display is changed.

According to an embodiment of the present invention, there is provided a driving apparatus for a display device, wherein the driving apparatus determines an inversion driving mode of the display device based on an input control signal and outputs a common voltage that minimizes or prevents flicker for the determined inversion driving mode.

### BRIEF DESCRIPTION OF THE DRAWINGS

FIG. 1 is a block diagram of a liquid crystal display according to an exemplary embodiment of the present invention.

FIG. 2 is an equivalent circuit diagram of one pixel in a liquid crystal display according to an exemplary embodiment of the present invention.

FIG. 3 is a graph showing flicker numbers depending on inversion modes in a liquid crystal display according to an exemplary embodiment of the present invention.

FIG. 4 is a block diagram of a signal modification unit according to an exemplary embodiment of the present invention.

FIG. 5 is a block diagram illustrating an operation of the signal modification unit shown in FIG. 4.

FIG. 6 illustrates waveforms of gate-on signals for describing a method of removing or reducing flicker in a liquid crystal display according to an exemplary embodiment of the present invention.

FIG. 7 is a circuit diagram illustrating a portion of a signal modification unit of a liquid crystal display according to an exemplary embodiment of the present invention.

FIG. 8A is a block diagram of a signal modification unit according to an exemplary embodiment of the present invention.

FIG. 8B is a block diagram showing an exemplary data table stored in a memory unit according to an exemplary embodiment of the present invention.

### DETAILED DESCRIPTION OF THE EMBODIMENTS

The embodiments of the present invention will be described in more detail with reference to the accompanying drawings, wherein like reference numerals may be used to designate like or similar elements throughout the specification and the drawings. It will be understood that when an element such as a layer, film, region, or substrate is referred to as being “on” another element, it can be directly on the other element or intervening elements may also be present.

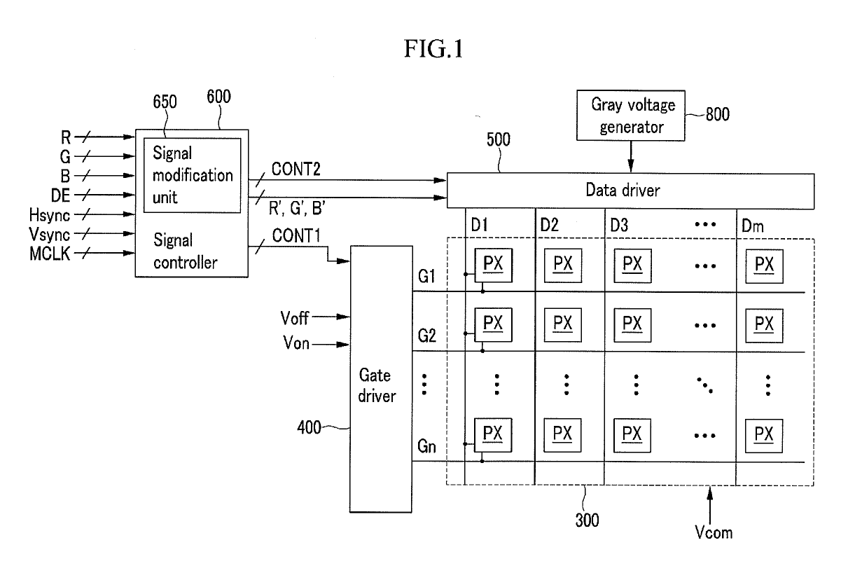

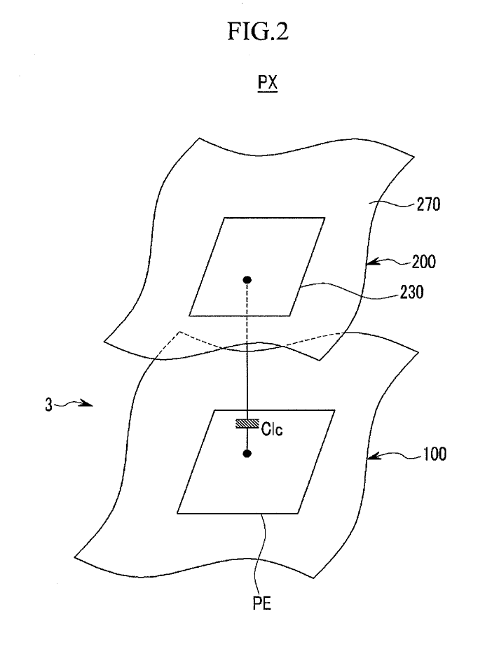

A liquid crystal display according to an exemplary embodiment of the present invention will be described with reference to FIG. 1 and FIG. 2.

FIG. 1 is a block diagram of a liquid crystal display according to an exemplary embodiment of the present invention, and FIG. 2 is an equivalent circuit diagram of a pixel in a liquid crystal display according to an exemplary embodiment of the present invention.

Referring to FIG. 1, a liquid crystal display according to an exemplary embodiment of the present invention includes a liquid crystal panel assembly 300, a gate driver 400, a data driver 500, a gray voltage generator 800, and a signal controller 600. The signal controller 600 includes a signal modification unit 650. Alternatively, the signal modification unit 650 is disposed outside the signal controller 600.

Referring to FIG. 1, the liquid crystal panel assembly 300 includes a plurality of signal lines G1-Gn and D1-Dm, and a plurality of pixels PX arranged substantially in a matrix pattern. As shown in FIG. 2, the liquid crystal panel assembly 300 includes a lower panel 100 and an upper panel 200 facing each other, and a liquid crystal layer 3 interposed between the lower panel 100 and the upper panel 200.

The signal lines G1-Gn and D1-Dm include a plurality of gate lines G1 to Gn for transmitting gate signals (also referred to as “scanning signals”), and a plurality of data lines D1 to Dm for transmitting data signals. The gate lines G1 to Gn are arranged in parallel to each other and extend substantially in a row direction, and the data lines D1 to Dm are arranged in parallel to each other and extend substantially in a column direction.

Each pixel PX, for example a pixel PX that is connected to an i-th gate line Gi (i=1, 2, . . . , and n) and a j-th data line Dj (j=1, 2, . . . , and m), includes a switching element that is connected to the signal lines Gi and Dj, and a liquid crystal capacitor Clc and a storage capacitor Cst that are connected to the switching element. According to an embodiment, the storage capacitor Cst is omitted.

The switching element is a three terminal element, such as a thin film transistor, which is provided to the lower panel 100. A control terminal of the switching element is connected to the gate line Gi, an input terminal of the switching element is connected to the data line Dj, and an output terminal of the switching element is connected to the liquid crystal capacitor Clc and the storage capacitor Cst.

The liquid crystal capacitor Clc has, as two terminals of the liquid crystal capacitor Clc, a pixel electrode PE of the lower panel 100 and a common electrode 270 of the upper panel 200. The liquid crystal layer 3 between the two electrodes PE and 270 serves as a dielectric material. The pixel electrode PE is connected to the switching element. The common electrode 270 is formed on the whole surface of the upper panel 200 and receives a common voltage Vcom. According to an embodiment, the common electrode 270 is formed on the lower panel 100. According to an embodiment, at least one of the two electrodes PE and 270 has a linear shape or a bar shape.

The storage capacitor Cst that serves as an auxiliary capacitor of the liquid crystal capacitor Clc is formed by a separate signal line (not shown) provided on the lower panel 100 and the pixel electrode PE, with an insulator interposed between the separate signal line and the pixel electrode PE. A predetermined voltage, such as a common voltage Vcom or the like, is applied to the separate signal line. According to an embodiment, the storage capacitor Cst is formed by the pixel electrode PE and a gate line that overlaps the pixel electrode PE via the insulator.

Each pixel PX separately represents one of primary colors (for example, spatial division) or sequentially represents the primary colors (for example, temporal division) such that a spatial or temporal combination of the primary colors represents a desired color. The primary colors include red, green, and blue colors. FIG. 2 shows an example of the spatial division in which each pixel PX includes a color filter 230 for representing one of the primary colors in an area of the upper panel 200 that corresponds to the pixel electrode PE. The color filter 230 is made of an organic insulator.

The liquid crystal panel assembly 300 includes at least a polarizer (not shown) for providing light polarization.

Next, a driving apparatus of a liquid crystal display according to an exemplary embodiment of the present invention will be described.

Referring again to FIG. 1, the gray voltage generator 800 generates all gray voltages or a predetermined number of gray voltages (or reference gray voltages) relating to transmittance of the pixels PX. The (reference) gray voltages include positive values and negative values with respect to a common voltage Vcom.

The gate driver 400 is connected to the gate lines G1 to Gn of the liquid crystal panel assembly 300, and applies gate signals obtained by combining a gate-on signal Von and a gate-off signal Voff to the gate lines G1 to Gn.

The data driver 500 is connected to the data lines D1 to Dm of the liquid crystal panel assembly 300. The data driver 500 selects the gray voltages from the gray voltage generator 800 and applies the selected gray voltages to the data lines D1-Dm as data signals. According to an embodiment, when the gray voltage generator 800 supplies only a predetermined number of reference gray voltages to the data driver 500, the data driver 500 divides the reference gray voltages to generate the data signals.

The signal controller 600 controls the gate driver 400 and the data driver 500. The signal controller 600 includes the signal modification unit 650.

According to embodiments, each of the drivers 400 and 500, the signal controller 600, and the gray voltage generator 800 is directly mounted on the liquid crystal panel assembly 300 in the form of at least an IC chip, is mounted on a flexible printed circuit film (not shown) that is then mounted on the liquid crystal panel assembly 300 in the form of a tape carrier package (TCP), or is mounted on a separate printed circuit board (not shown). Alternatively, the drivers 400 and 500, the signal controller 600, and the gray voltage generator 800 are integrated with the liquid crystal panel assembly 300 together with, for example, the signal lines G1-Gn and D1-Dm and thin film transistor switching elements. According to an embodiment, the drivers 400 and 500, the signal controller 600, and the gray voltage generator 800 are integrated into a single chip. According to an embodiment, at least one of the drivers 400 and 500, the signal controller 600, and the gray voltage generator 800 or at least one of circuits forming the drivers 400 and 500, the signal controller 600, and the gray voltage generator 800 are arranged outside the single chip.

Next, an operation of a liquid crystal display according to an embodiment of the present invention will be described.

The signal controller 600 receives input image signals R, G, and B and input control signals to control display of the image signals R, G, and B from a graphics controller (not shown). The input image signals R, G, and B contain luminance information of each pixel (PX). The luminance has a predetermined number of gray levels, such as 1024=2¹⁰, 256=2⁸, or 64=2⁶. For examples, the input control signals include a vertical synchronization signal Vsync, a horizontal synchronization signal Hsync, a main clock signal MCLK, a data enable signal DE, or the like.

The signal controller 600 processes the input image signals R, G, and B to be suitable for operating conditions of the display panel unit 300 based on the input control signals, and generates a gate control signal CONT1 and a data control signal CONT2. The signal controller 600 outputs the gate control signal CONT1 to the gate driver 400, and outputs the data control signal CONT2 and modification image signals R′, G′, and B′ to the data driver 500.

The signal modification unit 650 of the signal controller 600 modifies the input signals to remove or reduce flicker according to an inversion mode by the input signals, and this is described below in greater detail.

The gate control signal CONT1 includes an image scanning start signal STV to instruct a start of image scanning, and at least one clock signal to control an output cycle of a gate-on signal. According to an embodiment, the gate control signal CONT1 further includes an output enable signal OE to define a duration of the gate-on signal.

The data control signal CONT2 includes a horizontal synchronization start signal STH indicating a transmission start of digital image data DAT for a column of pixels PX, a load signal LOAD to instruct the analog data signal to be applied to the image data lines D1-Dm, and a data clock signal HCLK. According to an embodiment, the data control signal CONT2 further includes an inversion signal RVS that inverts the polarity of the data signal for the common voltage Vcom, which is hereinafter also referred to as the “data signal polarity”.

The data driver 500 receives modification image signals R′, G′, and B′ for a column of pixels, and according to the data control signal CONT2 from the signal controller 600, selects gray voltages corresponding to the modification image signals R′, G′, and B′ and converts the modification image signals R′, G′, and B′ to analog data signals. Then, the data driver 500 supplies the analog data signals to respective corresponding data lines D1-Dm.

The gate driver 400 supplies a gate-on signal Von to a corresponding gate line of the gate lines G1-Gn according to the gate control signal CONT1 from the signal controller 600, thereby turning on a switching element Q connected to the corresponding gate line. The data signal supplied to the data lines D1-Dm is supplied to a corresponding pixel PX through the turned-on switching element Q. A difference between a voltage of the data signal applied to the pixels PX and the common voltage Vcom is a charged voltage of the liquid crystal capacitor Clc, for example, a pixel voltage. An arrangement of the liquid crystal molecules varies according to the magnitude of the pixel voltage so that the polarization of light passing through the liquid crystal layer 3 is changed.

A polarizer (not shown) converts the change in polarization to a change in light transmittance, and the pixel PX displays luminance corresponding to the gray level of the image signal DAT.

During a horizontal period, which is denoted as “1H” and is the same as a period of the horizontal synchronization signal Hsync and the data enable signal DE, the above-described operation is repeatedly performed to sequentially apply the gate-on signal Von to all the gate lines G1 to Gn, so that the data signals are applied to all the pixels PX. As a result, an image frame is displayed.

When display of the image frame ends, display of a next image frame starts. During the display of the next image frame, the reverse signal RVS applied to the data driver 500 is controlled so that the polarity of the data signal applied to each of the pixels is opposite to the polarity of the data signal applied during the display of the previous image frame (which is referred to as “frame inversion”). According to an embodiment, the inversion of polarity is implemented in various ways. For example, depending on characteristics of the reverse signal RVS, a polarity of a data signal flowing through a data line is regularly inverted during display of an image frame (which is referred to as “column and dot inversion”), or polarities of data signals applied to a row of pixels are changed during display of an image frame (which is referred to as “row and dot inversion”). A liquid crystal display according to an embodiment of the present exemplary embodiment eliminates or reduces flicker based on the characteristics of the inversion signal RVS, and this is described below in greater detail.

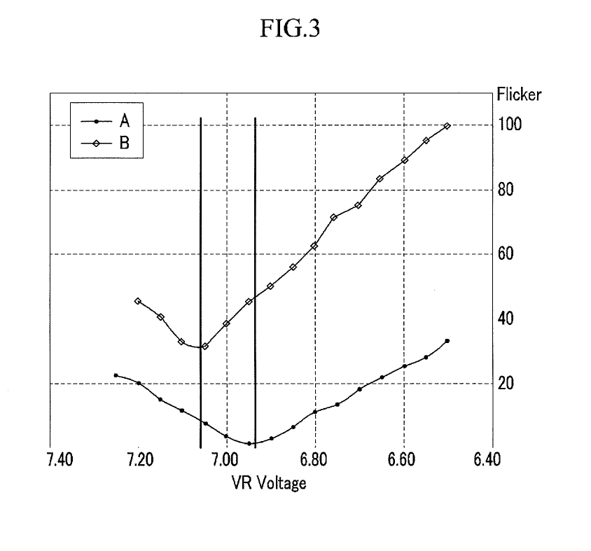

Next, removing or reducing flicker by the signal modification unit 650 of the signal controller 600 will be described with reference to FIG. 3 to FIG. 7.

FIG. 3 is a graph showing flicker numbers depending on inversion modes in a liquid crystal display according to an exemplary embodiment of the present invention.

Referring to FIG. 3, different common voltage values apply to a first inversion mode (A) and a second inversion mode (B) to suppress flicker in the liquid crystal display. For example, the first and second inversion modes (A) and (B) have different common voltage values that result in minimum or no flicker. Accordingly, in the case that flicker may be removed by using the second inversion mode, for example, a two frame inversion mode in which the polarity of the data signal is changed every two frames, if the liquid crystal display is actually driven with the first inversion mode, for example, a one frame inversion mode in which the polarity of the data signal is changed every frame, flicker may occur. Therefore, a common voltage value to minimize or eliminate flicker is applied for the first inversion mode. The reverse may also occur, for example, flicker may also occur when the liquid crystal display is driven in the second inversion mode even though flicker may be suppressed in the first inversion mode and a common voltage to minimize or eliminate flicker is applied for the second inversion mode. The graph of FIG. 3 is merely an example for description of an embodiment of the present invention, and various common voltage values may apply to eliminate or reduce flicker according to embodiments of the liquid crystal display.

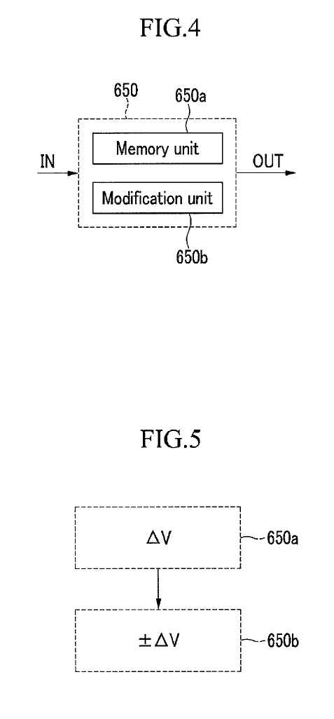

Next, a signal modification unit of a liquid crystal display according to an exemplary embodiment of the present invention is described in greater detail with reference to FIG. 4 and FIG. 5. FIG. 4 is a block diagram of a signal modification unit according to an exemplary embodiment of the present invention, and FIG. 5 is a block diagram illustrating an operation of the signal modification unit shown in FIG. 4.

Referring to FIG. 4, a signal modification unit 650 includes a memory unit 650a and a modification unit 650b. The memory unit 650a stores optimized common voltage values measured for every inversion driving mode and difference values between the measured common voltage values. According to an embodiment, the memory unit 650a includes an EEPROM (Electrically Erasable Programmable Read-Only Memory). The size of the stored data in the memory unit 650a including the optimized common voltage values and the difference values is small. The modification unit 650b includes a DVR (Digital Variable Resistor) that generates a common voltage based on an input signal.

Referring to FIG. 5, the signal modification unit 650 determines an inversion driving mode of the liquid crystal display from the input control signal, reads an optimized difference value (ΔV) for the determined inversion driving mode among the difference values stored in the memory unit 650a, and reflects the difference value (ΔV) to an offset of the DVR to generate a final common voltage Vcom according to the inversion driving mode. The generated final common voltage Vcom is input to the common electrode, such that flicker may be suppressed although the inversion driving mode is changed.

The liquid crystal display and the driving method of the liquid crystal display according to the exemplary embodiment may simply remove or reduce flicker without a high cost by using the signal modification unit including the memory and the DVR.

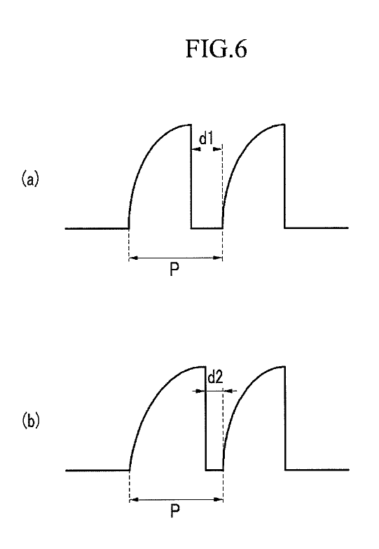

Next, a liquid crystal display and a driving method of the liquid crystal display according to an exemplary embodiment of the present invention will be described with reference to FIG. 6. FIG. 6 illustrates waveforms of gate-on signals for describing a method of removing or reducing flicker in a liquid crystal display according to an exemplary embodiment of the present invention.

A signal modification unit 650 of a liquid crystal display according to an exemplary embodiment determines an inversion driving mode based on an input control signal and changes duration of a gate-on signal according to the inversion driving mode. In detail, the signal modification unit 650 controls timing of a gate clock signal (CPV) according to the inversion driving mode to change the duration of the gate-on signal. According to an embodiment, the signal modification unit 650 is disposed outside the signal controller 600 and is connected to the gate driver 400.

For example, in the case that flicker occurs more often in a first inversion driving mode (a) than in a second inversion driving mode (b), wherein duration P-d2 of a gate-on signal in the second inversion driving mode (b) is longer than duration P-d1 of a gate-on signal in the first inversion driving mode (a) during the same period (P) as shown in FIG. 6, flicker occurring in the first inversion driving mode (a) may be reduced by adjusting the duration of the gate-on signal in the first inversion driving mode to be relatively longer so that the data signal is sufficiently charged to the liquid crystal layer.

As such, flicker varying according to inversion driving modes may be reduced by adjusting the timing of the gate clock signal to control the duration of the gate-on signal.

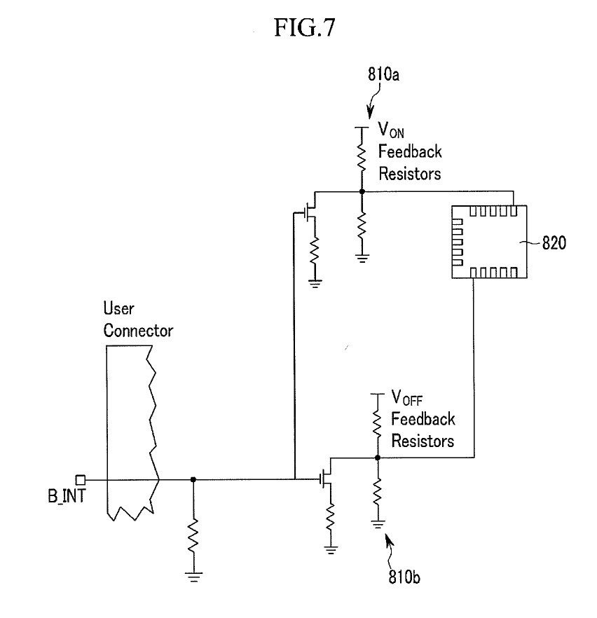

Next, a liquid crystal display and a driving method of the liquid crystal display according to an exemplary embodiment of the present invention will be described with reference to FIG. 7. FIG. 7 is a circuit diagram illustrating a portion of a signal modification unit of a liquid crystal display according to an exemplary embodiment of the present invention.

Referring to FIG. 7, a signal modification unit 650 of a liquid crystal display according to an exemplary embodiment adjusts the magnitude of the gate-on signal and the gate-off signal according to the input inversion driving signal B_INT to control the amount of electric charge in the liquid crystal layer, thereby removing or reducing flicker according to the inversion driving mode. In detail, the signal modification unit 650 inputs an inversion driving signal input according to the inversion driving mode to registers 810a and 810b, which respectively control the magnitude of the gate-on signal and the gate-off signal through a DC/ DC converter 820, to change the magnitude of the gate-on signal and the gate-off signal. Accordingly, flicker according to the inversion driving mode may be reduced. According to an embodiment, the signal modification unit 650 is disposed outside the signal controller 600 and is connected to the gate driver 400.

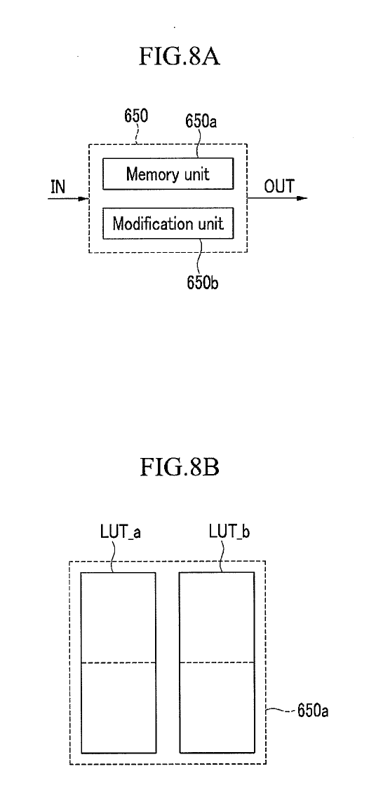

Next, a liquid crystal display and a driving method of the liquid crystal display according to an exemplary embodiment of the present invention will be described with reference to FIG. 8A and FIG. 8B.

FIG. 8A is a block diagram of a signal modification unit according to an exemplary embodiment of the present invention, and FIG. 8B is a block diagram showing an exemplary data table stored in a memory unit according to an exemplary embodiment of the present invention.

Referring to FIG. 8A, a signal modification unit 650 of the liquid crystal display according to an exemplary embodiment includes a memory unit 650a and a modification unit 650b, similar to the signal modification unit 650 described in connection with FIG. 4. Referring to FIG. 8B, a plurality of lookup tables LUT_a and LUT_b according to inversion driving modes are stored in the memory unit 650a of the signal modification unit 650. The modification unit 650b determines an inversion driving mode based on an input signal, reads a lookup table according to the determined inversion driving mode from the memory unit 650a, modifies image signals R, G, and B with respect to the common voltage Vcom for removing or reducing flicker, and outputs modification image signals R′, G′, and B′.

As such, the liquid crystal display according to the exemplary embodiment of the present invention stores the plurality of lookup tables LUT_a and LUT_b determined for every inversion mode in the memory and outputs the modification image signals to remove or reduce flicker according to the inversion mode. As described above, flicker is modified or prevented without an additional driver and an additional circuit portion, thus reducing costs of the liquid crystal display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving apparatus of a liquid crystal display, comprising
a signal modification unit that determines an inversion driving mode of the liquid crystal display and performs a modification operation according to the determined inversion driving mode.

2. The driving apparatus of claim 1, wherein the inversion driving mode includes a first inversion driving mode and a second inversion driving mode, wherein
a first modification common voltage for the first inversion driving mode and a second modification common voltage for the second inversion driving mode are different from each other, and wherein
the signal modification unit includes a memory unit storing the first modification common voltage and the second modification common voltage.

3. The driving apparatus of claim 2, wherein
the signal modification unit includes a digital variable resistor (DVR) that generates the first and second modification common voltages.

4. The driving apparatus of claim 3, wherein
the modification operation includes changing an offset of the digital variable resistor (DVR) according to a difference between the first modification common voltage and the second modification common voltage from the memory unit.

5. The driving apparatus of claim 1, wherein
the modification operation includes changing duration of a gate-on signal.

6. The driving apparatus of claim 5, wherein
changing the duration of the gate-on signal is performed by controlling timing of a gate clock signal (CPV).

7. The driving apparatus of claim 1, wherein
the modification operation includes changing a magnitude of a gate-on signal and a magnitude of a gate-off signal.

8. The driving apparatus of claim 7, wherein
the signal modification unit inputs an inversion driving signal to a register controlling the magnitude of the gate-on signal and the magnitude of the gate-off signal through a DC/ DC converter.

9. The driving apparatus of claim 1, wherein
the inversion driving mode includes a first inversion driving mode and a second inversion driving mode, and wherein
the signal modification unit includes a memory unit storing a first lookup table for the first inversion driving mode and a second lookup table for the second inversion driving mode.

10. The driving apparatus of claim 9, wherein
the modification operation includes reading one of the first lookup table and the second lookup table from the memory according to the determined inversion driving mode and outputting a modification image signal according to the read lookup table.

11. A driving method of a liquid crystal display, comprising:
determining an inversion driving mode of the liquid crystal display based on an input control signal; and
performing a modification operation according to the determined inversion driving mode.

12. The driving method of claim 11, wherein
the inversion driving mode includes a first inversion driving mode and a second inversion driving mode, wherein
a first modification common voltage for the first inversion driving mode and a second modification common voltage for the second inversion driving mode are different from each other, and wherein
the driving method further includes reading the first modification common voltage and the second modification common voltage from a memory unit storing the first modification common voltage and the second modification common voltage.

13. The driving method of claim 12, further comprising:
changing an offset of a digital variable resistor (DVR), which generates the first and second modification common voltages, according to a difference of the first modification common voltage and the second modification common voltage.

14. The driving method of claim 11, further comprising:
changing duration of a gate-on signal.

15. The driving method of claim 14, wherein
changing the duration of the gate-on signal is performed by controlling timing of a gate clock signal (CPV).

16. The driving method of claim 11, further comprising:
changing a magnitude of a gate-on signal and a magnitude of a gate-off signal.

17. The driving method of claim 16, further comprising:
inputting an inversion driving signal to a register controlling the magnitude of the gate-on signal and the magnitude of the gate-off signal through a DC/ DC converter.

18. The driving method of claim 11, wherein
the inversion driving mode includes a first inversion driving mode and a second inversion driving mode, and wherein
the driving method further includes reading one of a first lookup table for the first inversion driving mode and a second lookup table for the second inversion driving mode from a memory unit storing the first lookup table and the second lookup table and outputting a modification image signal according to the read lookup table.

19. A driving apparatus for a display device, wherein the driving apparatus: determines an inversion driving mode of the display device based on an input control signal; and outputs a common voltage that minimizes or prevents flicker for the determined inversion driving mode.
